(19) United States
(12) Patent Application Publication
(10) Pub. No.: US 2026/0177158 A1
(43) Pub. Date: Jun. 25, 2026

(54) PRESS TYPE CUP LID

(71) Applicant: Yongkang Rixin Metal Products Co., Ltd., JINHUA (CN)

(72) Inventor: Jianfei Xu, Quzhou (CN)

(21) Appl. No.: 19/537,374

(22) Filed: Feb. 11, 2026

(30) Foreign Application Priority Data
Oct. 14, 2025 (CN) 202522167160.1

(51) Int. Cl. F16K 15/14; F16K 15/03; F16K 15/04

(52) U.S. Cl. CPC F16K 15/148; F16K 15/036; F16K 15/038; F16K 15/04; F16K 15/147; B65D 2543/00046; B65D 2543/00296

(57) ABSTRACT

The invention relates to the field of cups, in particular to a press type cup lid, including a housing provided with a water outlet. The housing is also provided with a water inlet passage, a water storage passage and a water outlet passage. The water outlet is connected to the water outlet passage. A first check valve communicating with the water inlet passage and a second check valve communicating with the water outlet passage are arranged on the water storage passage. A piston is slidably connected into the water storage passage. When the piston is pulled outwards, liquid enters the water storage passage from the water inlet passage. When the piston is pushed inwards, the liquid enters the water outlet passage from the water storage passage. The problem that existing cups cannot accurately control the amount of water drunk each time is solved.

### CROSS-REFERENCE TO RELATED APPLICATIONS

This application claims priority to Chinese Patent Application No. 202522167160.1, filed on Oct. 14, 2025, which is hereby incorporated by reference in its entirety.

### TECHNICAL FIELD

The invention relates to the field of cups, in particular to a press type cup lid.

### BACKGROUND

After exercise, the heart of athletes is still under high load. Drinking of a large amount of water at a time will quickly increase the blood volume, causing a sudden increase in the pressure of blood pumped by the heart, which may lead to chest tightness, arrhythmia and even a heart failure. However, drinking of a small amount of water multiple times may gently regulate the body fluid equilibrium and avoid violent fluctuations of the blood volume. Existing common cups cannot accurately control the amount of water drunk each time, thereby being prone to potential safety risks.

### SUMMARY

To solve the aforementioned problem that existing cups cannot accurately control the amount of water drunk each time, the invention provides a press type cup lid.

The technical solution adopted by the invention is as follows: a press type cup lid includes a housing provided with a water outlet, the housing is also provided with a water inlet passage, a water storage passage and a water outlet passage, the water outlet is connected to the water outlet passage, a first check valve and a second check valve are arranged on the water storage passage, the first check valve communicates with the water inlet passage, the second check valve communicates with the water outlet passage, and a piston is slidably connected into the water storage passage; when the piston is pulled outwards, liquid enters the water storage passage from the water inlet passage; when the piston is pushed inwards, the liquid enters the water outlet passage from the water storage passage.

By adopting the above technical solution, when the press type cup lid is used by users, the piston is pulled outwards to generate a negative pressure in a cup, the first check valve is turned on, and liquid enters the water storage passage from the water inlet passage; then, the piston is pushed inwards by the users, at this moment, the first check valve is turned off, the second check valve is turned on, the liquid flows into the water outlet passage from the water storage passage and is sprayed out from water outlet, such that the amount of water drunk each time by the users is fixed, thereby avoiding potential safety risks after exercise.

Further, the press type cup lid further includes an elastic element, and the elastic element is connected to the piston and the housing.

By adopting the above technical solution, the piston, after being pressed, may return to the original position under the action of the elastic element, such that users may drink water multiple times.

Further, the piston includes a rubber head and a slide rod, and the rubber head is in circumferential contact with the water storage passage.

By adopting the above technical solution, the rubber head is in circumferential contact with the water storage passage, such that all liquid in the water storage passage may be discharged into the water outlet passage when the piston is pressed.

Further, a notch is formed in the housing, and an end of the slide rod is located outside the notch.

By adopting the above technical solution, the end of the slide rod is located outside the notch, such that users may press the piston easily.

Further, an axial extension direction of the piston is parallel to an axial extension direction of the first check valve and the second check valve.

By adopting the above technical solution, liquid may pass through the first check valve and the second check valve more easily by pressing and pulling the piston, thereby reducing resistance.

Further, a first mounting groove and a second mounting groove are formed in the housing, the first mounting groove fits the first check valve, and the second mounting groove fits the second check valve.

By adopting the above technical solution, the first check valve and the second check valve are mounted stably and are not prone to shaking.

Further, a first receding portion is arranged on two sides of the first mounting groove and used for limiting the first check valve, and a second receding portion is arranged on two sides of the second mounting groove and used for limiting the second check valve.

By adopting the above technical solution, the first receding portion and the second receding portion are respectively used for limiting the first check valve and the second check valve, such that the first check valve and the second check valve are mounted more stably.

Further, a stop plate is arranged in the housing, the slide rod is slidably connected to the stop plate, and when the rubber head is in contact with the stop plate, the piston is pulled outwards to the maximum extent.

By adopting the above technical solution, the rubber head is limited by the stop plate, thereby preventing the piston from disengaging from the housing.

### BRIEF DESCRIPTION OF THE DRAWINGS

To better clarify the technical solutions in the embodiments of the invention or the prior art, drawings used for describing the embodiments of the invention or the prior art are briefly introduced below. Obviously, the drawings described below merely illustrate some embodiments of the invention. Those ordinarily skilled in the art may obtain other drawings according to the structure illustrated by the following drawings without creative labor.

FIG. 1 is an overall structural view according to the invention.

FIG. 2 is an overall sectional view according to the invention.

FIG. 3 is a partial sectional view according to the invention.

### REFERENCE SIGNS

1, housing; 2, first check valve; 3, second check valve; 4, piston; 5, elastic element; 101, water outlet; 102, water inlet passage; 103, water storage passage; 104, water outlet passage; 105, notch; 106, first mounting groove; 107, second mounting groove; 108, first receding portion; 109, second receding portion; 110, stop plate; 401, rubber head; 402, slide rod.

The fulfilment of the purposes of the invention and the functional characteristics and advantages of the invention will be further described below with reference to the accompanying drawings.

### DESCRIPTION OF EMBODIMENTS

The technical solutions in the embodiments of the invention are clearly and completely described below in conjunction with accompanying drawings in the embodiments of the invention. Obviously, the embodiments described here are merely illustrative ones rather than all possible ones of the invention. All other embodiments obtained by those ordinarily skilled in the art based on the following ones without creative labor should also fall within the protection scope of the invention.

It should be noted that all directional indications (such as “upper”, “lower”, “left”, “right”, “front” and “back”) in the embodiments of the invention are merely used for explaining the relative positional relations or motions of components at a specific attitude, and once the specific attitude changes, the directional indications will change accordingly.

In addition, terms such as “first” and “second” involved in the invention are merely for the purpose of description, and should not be construed as indicating or implying relative importance or implicitly indicating the number of technical features referred to. Therefore, a feature defined by “first” or “second” may explicitly or implicitly indicate the inclusion of at least one said feature. In addition, the technical features in the embodiments may be combined as long as the combinations are implementable by those ordinarily skilled in the art. If a combination of the technical solutions leads to a conflict or is unimplementable, the combination should be construed as non-existent and should not fall within the protection scope of the invention.

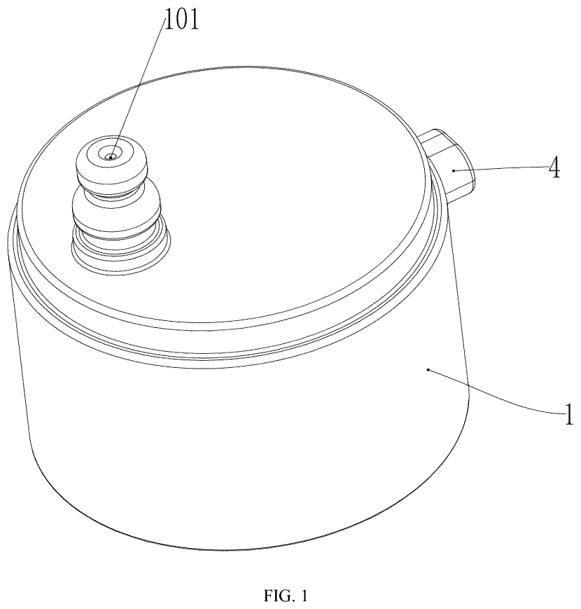

Referring to FIGS. 1-3, a press type cup lid includes a housing 1. The housing 1 is provided with a water outlet 101. The housing 1 is also provided with a water inlet passage 102, a water storage passage 103 and a water outlet passage 104. The water outlet 101 is connected to the water outlet passage 104. A first check valve 2 and a second check valve 3 are arranged on the water storage passage 103. The first check valve 2 communicates with the water inlet passage 102. The second check valve 3 communicates with the water outlet passage 104. A piston 4 is slidably connected into the water storage passage 103. When the piston 4 is pulled outwards, liquid enters the water storage passage 103 from the water inlet passage 102. When the piston 4 is pushed inwards, the liquid enters the water outlet passage 104 from the water storage passage 103.

When the press type cup lid is used by users, the piston 4 is pulled outwards to generate a negative pressure in a cup, the first check valve 2 is turned on, and liquid enters the water storage passage 103 from the water inlet passage 102; then, the piston 4 is pushed inwards by the users, at this moment, the first check valve 2 is turned off, the second check valve 3 is turned on, the liquid flows into the water outlet passage 104 from the water storage passage 103 and is sprayed out from water outlet 101, such that the amount of water drunk each time by the users is fixed, thereby avoiding potential safety risks after exercise.

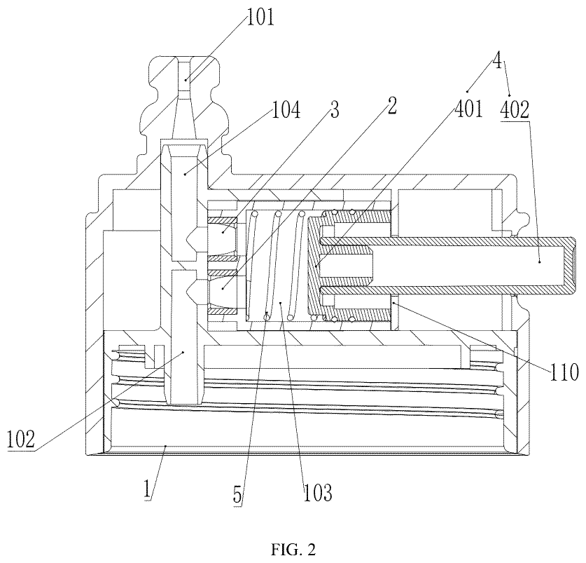

Referring to FIG. 2, the press type cup lid further includes an elastic element 5, and the elastic element 5 is connected to the piston 4 and the housing 1.

Under the action of the elastic element 5, the piston 4 may return to the original position after being pressed, such that users may drink water multiple times.

Preferably, the elastic element 5 is a spring.

Referring to FIG. 2, the piston 4 includes a rubber head 401 and a slide rod 402, and the rubber head 401 is in circumferential contact with the water storage passage 103.

The rubber head 401 is in circumferential contact with the water storage passage 103, such that all liquid in the water storage passage 103 may be discharged into the water outlet passage 103 when the piston 4 is pressed.

Referring to FIGS. 1 and 2, a notch 105 is formed in the housing 1, and an end of the slide rod 402 is located outside the notch 105.

The end of the slide rod 402 is located outside the notch 105, such that users may press the piston 4 easily.

Referring to FIG. 2, an axial extension direction of the piston 4 is parallel to an axial extension direction of the first check valve 2 and the second check valve 3.

Liquid may pass through the first check valve 2 and the second check valve 3 more easily by pressing and pulling the piston 4, thereby reducing resistance.

Referring to FIG. 2, a first mounting groove 106 and a second mounting groove 107 are formed in the housing 1, the first mounting groove 106 fits the first check valve 2, and the second mounting groove 107 fits the second check valve 3.

The first check valve 2 and the second check valve 3 are mounted stably and are not prone to shaking.

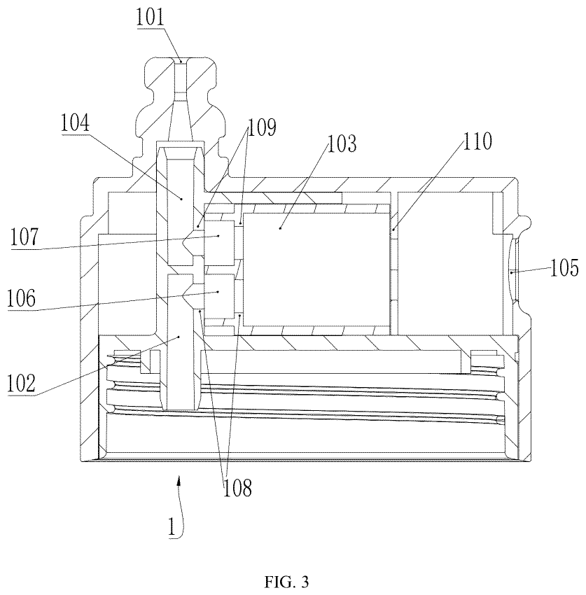

Referring to FIGS. 2 and 3, a first receding portion 108 is arranged on two sides of the first mounting groove 106 and used for limiting the first check valve 2, and a second receding portion 109 is arranged on two sides of the second mounting groove 107 and used for limiting the second check valve 3.

The first receding portion 108 and the second receding portion 109 are respectively used for limiting the first check valve 2 and the second check valve 3, such that the first check valve 2 and the second check valve 3 are mounted more stably.

Referring to FIG. 2, a stop plate 110 is arranged in the housing 1, the slide rod 402 is slidably connected to the stop plate 110, and when the rubber head 401 is in contact with the stop plate 110, the piston 4 is pulled outwards to the maximum extent.

The rubber head 401 is limited by the stop plate 110, thereby preventing the piston 4 from disengaging from the housing.

The above embodiments are merely preferred ones of the invention and are not intended to limit the patent scope of the invention. All equivalent structural transformations, or direct/indirect applications to other related technical fields made according to of the contents in the specification and the accompanying drawings of the invention based on the inventive concept of the invention should also fall within the patent protection scope of the invention.

What is claimed is:

1. A press type cup lid, comprising a housing provided with a water outlet, wherein the housing is also provided with a water inlet passage, a water storage passage and a water outlet passage, the water outlet is connected to the water outlet passage, a first check valve and a second check valve are arranged on the water storage passage, the first check valve communicates with the water inlet passage, the second check valve communicates with the water outlet passage, and a piston is slidably connected into the water storage passage; when the piston is pulled outwards, liquid enters the water storage passage from the water inlet passage; when the piston is pushed inwards, the liquid enters the water outlet passage from the water storage passage.

2. The press type cup lid according to claim 1, further comprising an elastic element, wherein the elastic element is connected to the piston and the housing.

3. The press type cup lid according to claim 2, wherein the piston comprises a rubber head and a slide rod, and the rubber head is in circumferential contact with the water storage passage.

4. The press type cup lid according to claim 3, wherein a notch is formed in the housing, and an end of the slide rod is located outside the notch.

5. The press type cup lid according to claim 4, wherein an axial extension direction of the piston is parallel to an axial extension direction of the first check valve and the second check valve.

6. The press type cup lid according to claim 5, wherein a first mounting groove and a second mounting groove are formed in the housing, the first mounting groove fits the first check valve, and the second mounting groove fits the second check valve.

7. The press type cup lid according to claim 6, wherein a first receding portion is arranged on two sides of the first mounting groove and used for limiting the first check valve, and a second receding portion is arranged on two sides of the second mounting groove and used for limiting the second check valve.

8. The press type cup lid according to claim 7, wherein a stop plate is arranged in the housing, the slide rod is slidably connected to the stop plate, and when the rubber head is in contact with the stop plate, the piston is pulled outwards to the maximum extent.
